(19) United States
(12) Patent Application Publication
(10) Pub. No.: US 2024/0342518 A1
(43) Pub. Date: Oct. 17, 2024

(54) STRAPLESS PERSONAL RESPIRATOR

(71) Applicant: Spencer Sutherland, Spring Creek, NV (US)

(72) Inventor: Spencer Sutherland, Spring Creek, NV (US)

(21) Appl. No.: 18/755,669

(22) Filed: Jun. 27, 2024

Related U.S. Application Data
(63) Continuation-in-part of application No. 17/856,989, filed on Jul. 2, 2022.

(51) Int. Cl. A62B 23/02; A62B 9/06

(52) U.S. Cl. CPC A62B 23/02; A62B 9/06

(57) ABSTRACT

A personal breathing apparatus includes a housing having an exhaust port, at least one filter-port, and a mouth-port connecting to a mouthpiece which is held inside the user's mouth while worn. A mouthguard on the mouthpiece is claspable by the user's teeth. By design, the personal breathing apparatus is balancable at the mouthpiece, such that the portion of the apparatus outside of the user's mouth is no heavier than the portion inside the user's mouth. In this way, the apparatus can be retained only by the clenching action of the user's teeth for long periods of time with no duress to the user. No head strap or other retention fastener is required.

### CROSS-REFERENCE TO RELATED APPLICATION(S)

The present application is related to and claims priority to U.S. Non-Provisional patent application Ser. No. 17/856,989 filed Jul. 2, 2022, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of filtered face masks of existing art and more specifically relates to personal breathing masks.

### RELATED ART

Personal breathing devices such as respirators are used in many industries. Government regulations have for many years required the use of respirators. Contaminants in the air have been studied and standards for particulates in the air of a workplace environment have been set. For a worker to function in a healthy environment, the use of a respirator is required. The style of respirator used in the work environment is bulky, restrictive, and only used when absolutely necessary. Furthermore, the commonly used conventional respirator is heavy, requires a shaven face, and limits visibility. Such traditional bulky respirators typically seal across the front of the face, and due to their forwardly-biased balance and excessive weight, require some sort of strap passing around the back of the head or neck to retain the respirator to the face. A suitable solution which eliminates these shortcomings is desired.

U.S. Pat. No. 7,025,060 to Alexander J. G. Nicholson relates to a personal breathing filter. The described personal breathing filter includes a personal air filtration device that has a cylindrical exhalation tube, with a one-way valve thereon. Concentric around the periphery of the exhalation tube and integrally connected to the exhalation tube rearward (proximate the user's mouth) of the one-way valve is a filter media housing. Filter media is contained between the housing and the tube. A plurality of perforations in the exhalation tube, rearward of the one way valve but forward from the housing connection ring, provide inhaled air ingress to the exhalation tube. Inhaled air forces the one-way valve closed, so that air is directed through the filter media, passes through the perforations and into the exhalation tube where the user can take in the cleansed air. The pressure of the exhaled air through the exhalation tube causes the one-way valve to open, so that exertion by the user is minimized. This patent to Nicholson is representative of previous attempts to improve traditional respirators.

### SUMMARY OF THE INVENTION

In view of the foregoing disadvantages inherent in the known personal breathing mask art, the present disclosure provides an improved personal breathing apparatus and method. The general purpose of the present disclosure, which will be described subsequently in greater detail, is to provide an effective and efficient personal breathing apparatus and method. A principle objective of the present disclosure is to provide a personal respirator which needs only contact the user at the mouth and the nose. In some embodiments, the respirator may be usable with contact at the mouth alone. In this way, the respirator described offers greater usability with other personal protection, such as protective headwear.

A personal breathing apparatus includes a housing having an exhaust port, at least one filter-port, and a mouth-port connecting to a mouthpiece which is held inside the user's mouth while worn. A mouthguard on the mouthpiece is claspable by the user's teeth. The apparatus can be retained only by the clenching action of the user's teeth for long periods of time with no duress to the user. However, in a preferred embodiment a nose clamp is also included. The purpose of the nose clamp is principally to prevent inhalation by the user through the nose, where no filtering is provided. No head strap or other retention fastener is required. Ergonomically, the respirator is designed to be donned and doffed with one hand, with a thumb and forefinger grasping on top and on bottom of the respirator. Check valves are provided in each interior passageway connecting a filter-port or exhaust-port to the mouth-port to prevent undesirable, unfiltered backflow. This is necessary because each port is in communication with a single common chamber adjacent to the mouth-port, and the exhaust-port is unfiltered. Therefore, in order to prevent inhalation through the exhaust-port, as well as to prevent unnecessary exhalation and introduction of moisture to the filters, check valves ensure that a user inhales through the filter-ports and exhales through the exhaust-port. In a preferred embodiment, two inlet filters straddle a single exhaust port as seen in a frontal view of the respirator. In some embodiments, three total check valves are provided.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an improved personal breathing apparatus and method, constructed and operative according to the teachings of the present disclosure.

FIG. 1 is a front perspective view of the personal breathing apparatus during an ‘in-use’ condition, according to an embodiment of the disclosure.

FIG. 2 is a front perspective view of the personal breathing apparatus of FIG. 1 with the check valve inlet assembly disassembled, according to an embodiment of the present disclosure.

FIG. 3 is a rear perspective view of the mouthpiece of the personal breathing apparatus of FIG. 1 illustrating the mouthpiece, according to an embodiment of the present disclosure.

FIG. 4 is a perspective view of the assembled inlet port of the personal breathing apparatus of FIG. 1 illustrating the interior airways, according to an embodiment of the present disclosure.

FIG. 5 is a bottom perspective view of the personal breathing apparatus showing the exhaust port, according to an embodiment of the present disclosure.

FIG. 6 is a rear perspective view of the nose-shield of the personal breathing apparatus of FIG. 1, according to an embodiment of the present disclosure.

FIG. 7 is a rear perspective view of the housing of the personal breathing apparatus of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to breathing apparatuses and more particularly to an improved personal breathing apparatus and method as used to improve the efficient and effective use of breathing apparatus.

Generally, the personal breathing apparatus is a light weight, minimalistic housing having multiple attachment points for filters. The apparatus replaces a conventional face-mask style respirator. The housing includes attachment points for air filters. The housing may also be referred to herein as a manifold, especially where the housing is integrated with the exhaust cover. The manifold is characterized by a plurality of air passages which convey filter air to the user and convey exhaled air away from the user. The air filter attachment points are designed such that either custom or standardized air filters can be attached depending on embodiment. A For example, in an embodiment accepting standardized filters, a P-100 filter material is envisioned as an ideal filtering material, and a 3M 2097 is one preferable model of filter to be used in conjunction with the respirator. Bayonet-type filter attachments may also be envisioned, but other styles may be implemented. Alternatively, as in the illustrated embodiment, a filter may be affixed using a threaded interface. As shown, the filter may contain a female thread, while the right and left inlets of the respirator housing feature a male thread. This design is advantageous for maximum sealing effectiveness, utilizing an O-ring exterior to the male inlet threads. By design, a user can attach and replace any portable air filter with ease with full functionality. A mouthpiece is inserted into the mouth when worn, and has a U-shaped deformable appendage which a user may bite upon to retain the respirator in their mouth. Sea-Cure is seen as an optimal material for the deformable appendage of the mouthpiece. In some embodiments, the mouthpiece may be weighted to balance the respirator assembly. Such a method of retention is desirable, because with the teeth clenched in this way, it has been found that the user salivates less while wearing the respirator. Additionally, the mouthpiece appendage is sufficiently deformable that it can be easily formed for users having differently sized mouths, and the provision of different sizes, or burdensome fitting, is not necessary. Centrally to the U-shaped mouthpiece appendage, and facing into the opening of the U-shape, is an aperture which is in communication with the interior channels of the respirator, and it is through this aperture that the user inhales and exhales. Sealing of the mouth to the respirator is enacted entirely by the closing of the user's lips. Advantageously, this means that no external fitting of the respirator to the user's face is necessary, and the respirator is easily usable by users with abnormally shaped faces, as well as bearded individuals. Furthermore, because the respirator does not hug about the top of the user's nose, sufficient clearance is given to wear fully protective Z87 eyewear. The reduced surface contact of the respirator to skin improves comfort of the user, especially in hot environments, as the respirator will not retain heat against the user's face.

Preferably, no airflow communication with the nostrils are provided. Rather, a noseclip may be affixed to the top of the respirator housing, which may be positioned over the bridge of the nose in use, clamping on either side of the nose to close the nostrils. This function ensures that all inhalation and exhalation is passed through the mouthpiece of the respirator. Additionally, the noseclip may provide some additional stability to the respirator on the user's face, although this is deemed an optional feature, and not always necessary to the effective use of the respirator.

In some embodiments, the manifold may be split into the housing and the exhaust cover. In such an embodiment, the exhaust cover may affix to the front of the housing (covering the exhaust port) via magnets, detents, fasteners, or other mechanisms.

However, in a preferred and illustrated embodiment, the housing containing the air chamber and the exhaust cover are unitary. The exhaust port is concealed by the exhaust cover, the exhaust cover acting as a shield, with a downward-pointing opening defining a concealed chamber between the exhaust cover and the exhaust port. The exhaust port may be a circular, grated opening, which need not be filtered, since air is leaving the respirator here. Preferably, a check valve is provided to prevent inhalation by a user through the exhaust port. In such an embodiment, the check valve may be provided at the exhaust port or elsewhere inside the manifold. As illustrated, the exhaust cover is unitary with the rest of the housing.

In the illustrated embodiment, filters are attached to the left and right inlets by a threaded connection. This threaded connection may be an intermittent thread. Preferably, an O-ring is applied to the exterior of the threading, and is compressed between the filter and the manifold when the filter is threaded to either the left or right inlet. In side each inlet, a valve and valve holder is supplied. These may be “cupped” inserts, and the valve may be a deformable flap which is connected centrally to the valve holder. This deformable flap acts as a check valve, as if air pressure is greater inside the manifold than at the filter, the flap is pressed against the valve holder and seals against the inside of the inlet. However, if air pressure is greater at the filter (and outside the manifold) than inside the manifold, the flap will deform inwardly, breaking the seal and permitting air passage from the filter to the inside of the manifold, air passing primarily around the periphery of the deformable flap.

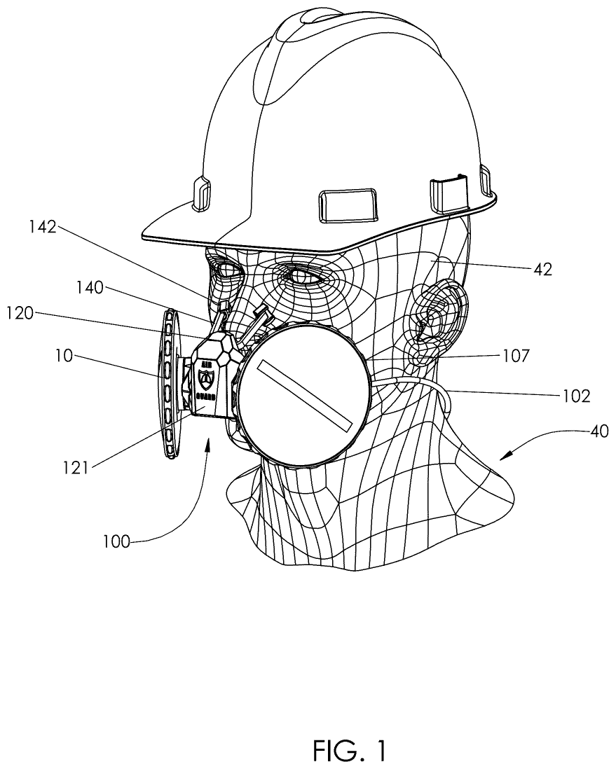

Referring now more specifically to the drawings by numerals of reference, there is shown in FIGS. 1-7, various views of a personal breathing apparatus 100.

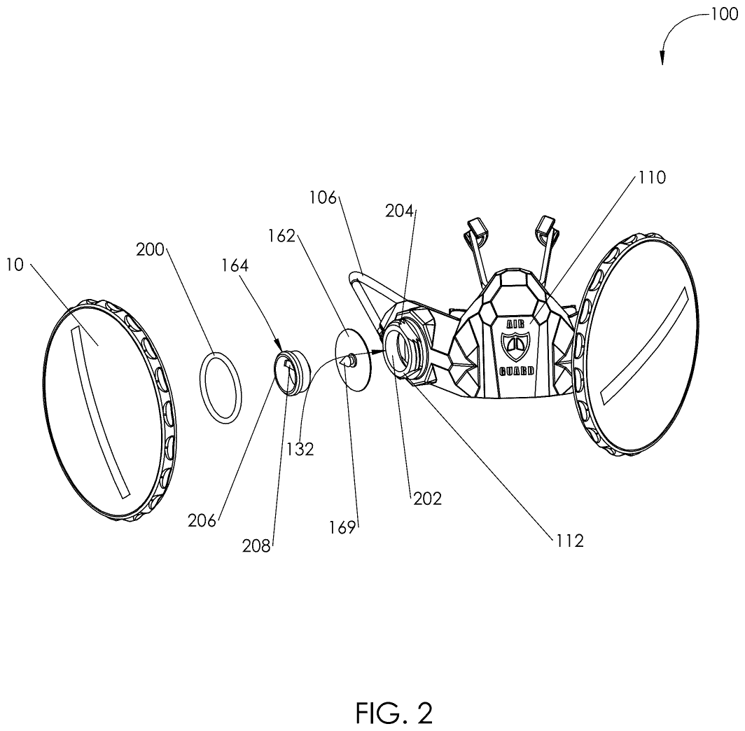

FIG. 1 shows a personal respirator during an ‘in-use’ condition, according to an embodiment of the present disclosure. Personal respirator 100 may be worn by user 40 over the face 42. Filters 10 may be affixed to personal respirator 100 to filter air being inhaled by user 40. Preferably, no gaskets are provided to seal filter 10 to personal respirator 100, but the compression of filter 10 to housing 110 (FIG. 2) is sufficient to seal filter 10 to personal respirator 100.

As illustrated in FIG. 1 in a usable, filtering condition, at least one filter 10 (FIG. 1) is releasably attachable to at least one filter-port 112. Here in FIG. 2 at least one filter-port 112 is illustrated exposed, without filter 10 (FIG. 1) attached. In some embodiments, at least one filter port 112 is externally characterized by bayonet connectors 116 as shown. Preferably, bayonet connectors 116 are a triad of outwardly-facing tabs that are each separated from each other by 120-degrees on center, and are sized and arranged such that a filter 10 (FIG. 1) (such as a 3M 2097 type filter) may be attached by pressing the filter 10 (FIG. 1) onto the at least one filter port 112 and rotating it until filter 10 (FIG. 1) is locking into the tabs of bayonet connector 116. Here, housing 110 may form a pair of lateral sides 118 to the left and right, forming wings which extend to the left and right sides respectively of the face of the user 40 (FIG. 1) when worn. These wings may be characterized by corresponding wings of the interior passageways as well. To these lateral sides 118, at least one filter-ports 112 may be embedded, advantageously placing the filters 10 (FIG. 1) to the sides of the face of user 40 (FIG. 1) when worn.

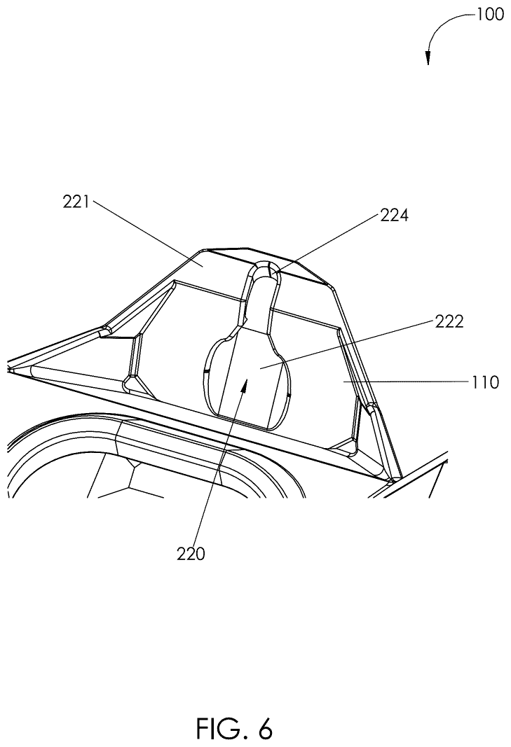

Housing 110 may be constructed of resin. Resin has been found as an ideal material for constructing housing 110 for weight distribution purposes; however, other materials such as polymers, rubber, and silicone may also be used so long as the weight distribution does not bias the center of gravity of the respirator in front of the mouthpiece. Resin has been found to have a sufficiently high strength-to-weight ratio that the housing may be constructed light enough to not overbalance mouthpiece 150. See FIG. 6 for illustrations of weight distribution characteristics.

Respirator 100 may further comprise upper shield 120, which may be unitary to or attached to housing 110. Upper shield 120 may be disposed over the nose of user 40 (FIG. 1) when worn. Preferably, upper shield 120 provides a structurally rigid and tactile spot for a user to grasp respirator 100 when donning and doffing. In some embodiments, exhalation port 114 may perforate upper shield 120. However, in other embodiments, exhalation port 114 may simply perforate housing 110, being concealed by upper shield 120 and front shield 121. In such an embodiment, slots may perforate upper shield 120, and front shield 121 may simply cover an airspace such that concealed exhalation port 114 communicates freely with the slots of upper shield 120. Furthermore, upper shield 120 may provide a structurally sound mounting point for nose clamp arms 140.

Respirator 100 may include a nose clamp affixed to an upper end of housing 110 proximate to or connected to upper shield 120. Nose clamp may include a pair of curved arms 140 as shown, mirrored over a center line of respirator 100 from a frontal view, and being outwardly convex, such that the left and right arms of the pair of curved arms 140 circle around the left and right sides of the nose of user 40 (FIG. 1) respectively. Curved arms 140 are resilient but sufficiently springy to be opened wide to fit around the nose when donned, and then apply pressure to both sides of the nose simultaneously when worn, applying pressure directly over the nasal cavity interior to the nose. Nose clamp ends 142 are affixed to the termini of curved arms 140 and provide a wider cushioned surface able to apply pressure more comfortably to the nose. Nose clamp ends 142 are preferably dome-shaped and may be constructed of a soft elastic material such as rubber or silicone for superior comfort.

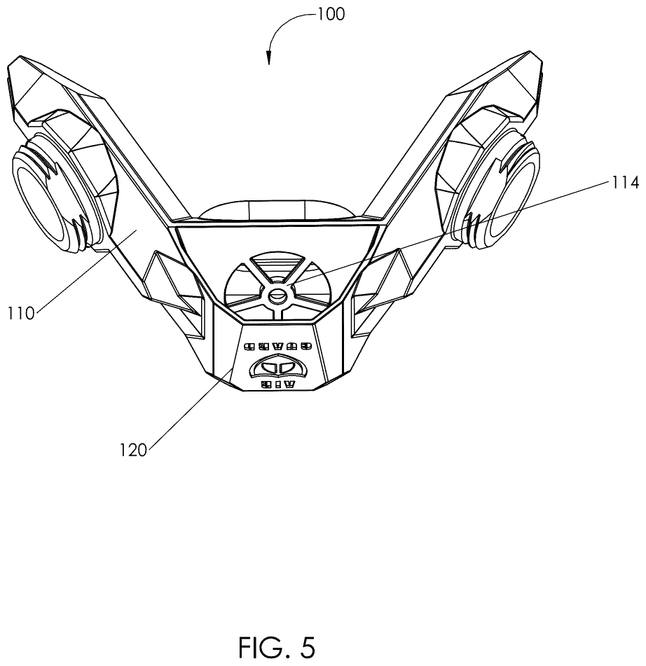

Housing 110 may also include a left-breakaway socket 105 (FIG. 5) and a right-breakaway socket 106, as well as lanyard 102. Lanyard 102 may have a left-end 107 able to fasten to the left-breakaway socket 105 (FIG. 5) and a right-end 108 able to fasten to the right-breakaway socket 106, such that the left-end 107 detaches from the left-breakaway socket 105 (FIG. 5) when subjected to a tension of a predetermined force. In one embodiment, the predetermined force may be five pounds or greater. Likewise, the right-end 108 detaches from the right-breakaway socket 106 when subjected to a tension of the predetermined force. Lanyard 102 may also include cord retainer 104 having a button to release tension from lanyard 102, such that lanyard 102 may be lengthened or shortened according a wearer's preference. It should be noted that lanyard 102 is not intended to retain respirator 100 to the face of the user 40 (FIG. 1) when worn, and should not be fully tightened to the back of the neck when worn. As shown, lanyard 102 is connected too low on housing 110 to effectively perform this type of retention, as housing 110 is weighted too high and would pitch forward when worn if this was the retention mechanism. Rather, respirator 100 is retained to user 40 (FIG. 1) only by the clenching of the teeth and lips on mouthpiece 150, and respirator 100 is so balanced as to be able to be retained this way without effort; specifically, the balance point of respirator 100 (front-to-back) is at the front of mouthpiece 150, at the lips of user 40 (FIG. 1). Due to this balance, respirator 100 is not biased to pitch forward when held by the teeth. The sole purpose of lanyard 102 is to hang respirator 100 about the neck of user 40 (FIG. 1) when not worn, such that user 40 (FIG. 1) need not worry about losing respirator 100 to misplacement or damage when not being used.

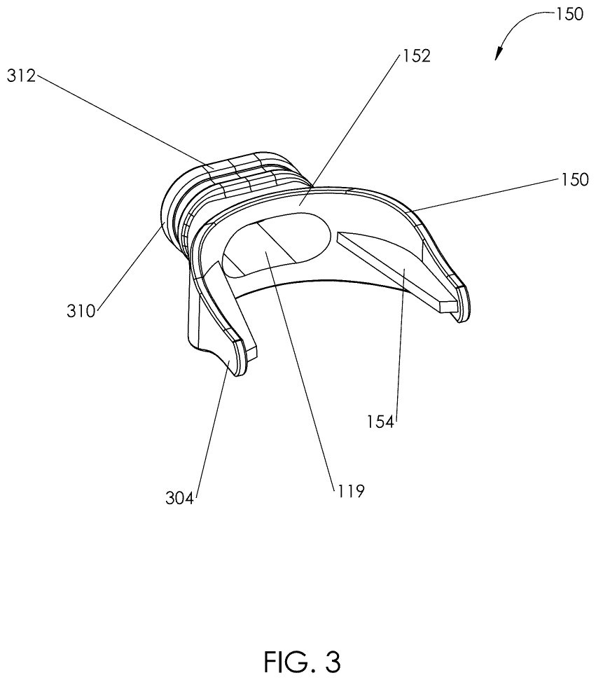

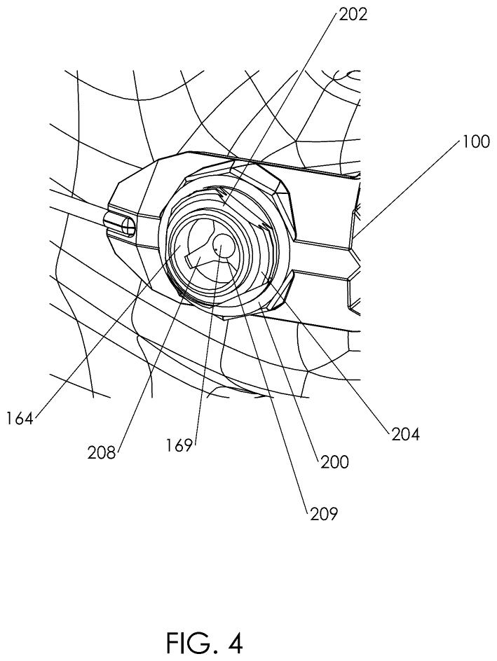

The personal respirator 100 in use, when worn, need only be retained by the user biting of the mouthpiece 150 (FIG. 3). As shown, personal respirator 100 may be worn and retained within the mouth of user 40 without any fastening devices such as a neck or headstrap. In some embodiments, housing 110 may be no more than fifty percent of the weight of personal respirator 100. Furthermore, personal respirator 100 is balanceable no further towards exhaust-port 114 (FIG. 4) than mouth-port 119 (FIG. 3), such that if mouthpiece 150 (FIG. 3) is held within the mouth, then the weight of housing 110 does not bias the personal breathing apparatus towards falling out of the mouth. In this embodiment, the axis of balance is placed approximately at the lips of user 40 when worn.

FIG. 2 shows the personal breathing apparatus 100 of FIG. 1, with the check-valve of one of the inlets disassembled, according to an embodiment of the present disclosure. As before, personal respirator 100 may include housing 110 and mouthpiece 150. Housing 110 may be characterized by exhaust-port 114 (FIG. 5), at least one filter-port 112, and mouth-port 119 (FIG. 3). Housing 110 may internally be characterized by one or more interconnected hollow passageways connecting each of at least one filter-port 112 and exhaust-port 114 (FIG. 5) with mouth-port 119 (FIG. 3), mouth-port 119 (FIG. 3) being integrated with mouthpiece 150 (FIG. 3). At least one filter-port 112 may also be referred to as the inhalation port, since all inhalation of user 40 (FIG. 1) will enter respirator 100 through at least one filter-port 112 when respirator 100 is worn by user 40 (FIG. 1).

Here, at least one filter-port 112 has an annular sidewall characterized by male threads 204 able to accept filter 10. Threads 204 may be interrupted, such that filter 10 may only need, for example, to be turned 60 degrees to be fastened to housing 110. O-ring 200 may fit on the outside of male threads 204, being able to rest against housing 110. When filter 10 is threaded to male threads 204, O-ring 200 is compressed between filter 10 and housing 110. Frame 164 (also referred to as a trident-frame in some embodiments where there are three spokes 208) has an annular lip 206, such that the cylindrical body of frame 164 may be inserted into the annular sidewall 202 of at least one filter-port 112, but the annular lip 206 is too wide to be inserted and stops resting upon the terminal end of at least one filter-port 112. When filter 10 is threaded to male thread 204, the frame 164 is sandwiched in between filter 10 and at least one filter-port 112, and is thereby retained. Flat and circular elastic membrane 162, acting as a checkvalve, is affixed through a central aperture of frame 164 using valve-fastener 169, which is a deformable cone-shaped fastener with an annular relief, such that the point of the cone may be pushed through the central aperture, and the annular relief is filled by the frame 164. Flat and circular elastic membrane 162 is wider in diameter than the bore of the filter-port 112, but can be deformed to pass through it during assembly. Flat and circular elastic membrane 162 must be wider than filter-port 112 in order to be able to seal against the inside of filter-port 112 and act as a checkvalve prevent backflow of filtered air out of the housing at the filter side.

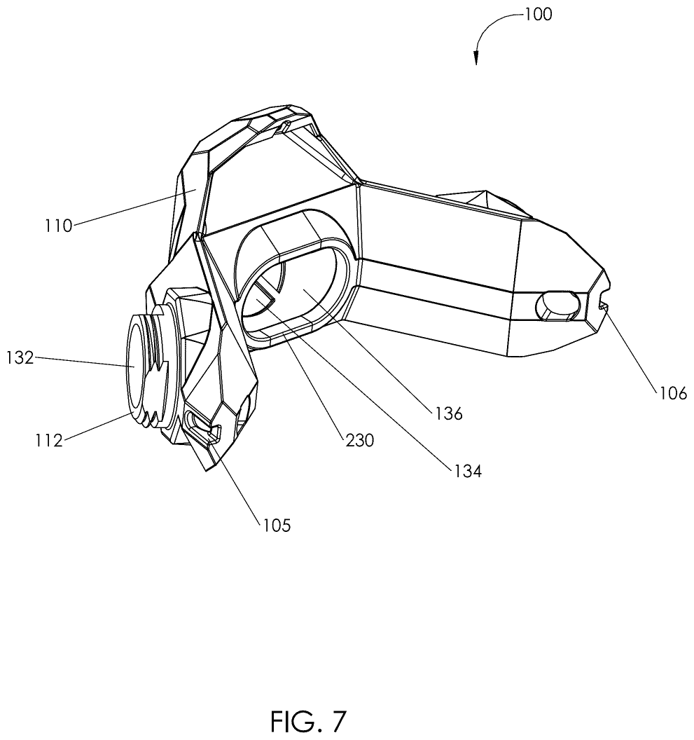

FIG. 3 is a rear view of the respirator 100 illustrating the mouthpiece 150. Mouthpiece 150 may itself be characterized by tooth-guard 152, tooth-shelf 154, and mouth-port 119. Tooth-guard 152 may be shaped as a strip curved into an arc, encircling and covering the front of the teeth. Tooth-shelf 154 may project interiorly to the arc from tooth-guard 152, and at a normal angle to tooth-guard 152, vertically central to tooth-guard 152, such that tooth-shelf 154 is claspable between the teeth of a user when the teeth are clenched. Tooth-guard 152 and tooth-shelf 154 may be formed of an elastic and deformable material such as rubber or silicone. Tooth-guard 154 may terminate on either end into skirt 304 having a narrower profile than the front, arched section of tooth-guard 154 to better fit into the edges of the mouth. Furthermore, in front of tooth-guard 154, mouthpiece 150 may extend forward in a rectangular, cylindrical, or otherwise extruded shape into connector 310. Connector 310 has a hollow passageway 119 to permit passage of air from the breathing passage 136 (FIG. 7) to the mouth of user 40 (FIG. 1). Furthermore, connector 310 terminated in rib 312, which is able to insert into and lock into port 230. The connection between connector 310 and port 230 should be airtight. Preferably, mouthpiece 150 is slightly deformable, being constructed out of silicone, rubber, polyethylene, or another resilient and elastic material, such that rib 312 can be simply pressed into port 230 in order to lock in place, being removable only with significant force.

FIG. 4 is a view of the filter-port 112 when assembled to housing 110. The checkvalve may include flat and circular elastic membrane 162, trident-frame 164, and valve-fastener 169. Flat and circular elastic membrane 162 may also be referred to as a with membrane or disk. Trident-frame 164 is a unitary component characterized three arms 166 and aperture 168. Each of three arms 166 able to slide into a corresponding slot 170 of filter-port 112, each of three arms 166 being parallel with each other and each three of the slot being parallel with each other. Trident-frame 164 may be an injection-molded polymer component. Valve-fastener 169 may be affixed centrally to (or be unitary with) flat and circular elastic membrane 162 and may be fastenable to aperture 168. Valve-fastener may be a conical projection with a narrower shaft connecting the conical projection to the circular elastic membrane 162, the conical projection being sufficiently deformable to be pushed through aperture 168, whereupon it expands and resists rearward withdrawl from aperture 169.

When flat and circular elastic membrane 162 is fastened by valve-fastener 169 to trident-frame 164, and trident-frame 164 is inserted into filter-port 112, flat and circular elastic membrane 162 covers and closes filter-port 112 against fluid communication with inlet-passage 132, such that when a vacuum is applied to inlet-passage 132, the flat and elastic circular elastic membrane will deform about the circumference and open filter-port 112 to fluid communication with inlet-passage 132. Flat and circular elastic membrane 162 is constructed of rubber, silicone, or another similarly deformable and elastic material which will naturally hold a flat and sealed position within the checkvalve.

Exhaust-valve 134 may include rectangular panel 180 able to cover exhaust-port 114 and close and seal exhaust-port 114 from fluid communication with outlet-passage 134, rectangular panel 180 being able to hinge upon an edge to open exhaust-port 114 to fluid communication with outlet-passage 134 when a pressure is applied to outlet-passage 134, whereby rectangular panel 180 is only able to hinge open away from exhaust-port 114, such that a pressure applied exteriorly to outlet-passage 134 will not open exhaust-port 114 to fluid communication with outlet-passage 134. Studs may be attached to or may be integral to rectangular panel 180, and may be insertable into bores in housing 110. However, the fitment of the bores to the studs must be sufficiently flexible to enable articulation of rectangular panel 180 over exhaust-port 114. This function may be further enacted by rounded or bulbous ends on the ends of the studs interfacing with rubber grommets within the bores. However, other retention and articulation mechanisms may be implemented.

FIG. 5 is a bottom perspective view of respirator 100. Here, the bottom opening into the cavity between exhaust-shield 120 and exhaust-port 114 can be seen. Exhaust-shield 120 is unitary to housing 110. Only this downward opening and exhaust-port 114 perforate the cavity; exhaust-shield is joined to housing 110 on the top, right side, and left side of exhaust-port 114. In this way, a user's breath is exhaled in a downwardly and safe direction.

FIG. 6 is a rear view of the nose shield of the personal respirator. Housing 110 may further include nose shield 221, which on a wearer-side, features noseclamp-interface 220. Noseclamp-interface 220 includes a dovetail 224 which can receive and retain a noseclamp assembly, and an opening 222 which widens dovetail 224 to a degree which the noseclamp assembly can be inserted into noseclamp-interface 220, before being slide into dovetail 224 for retention.

FIG. 7 is a rear view of respirator 100. As shown, housing 110 may internally be characterized by one or more interconnected hollow passageways 130 including inlet-passage 132, outlet-passage 134, and breathing-passage 136. In a preferred embodiment, each of inlet-passage 132, an outlet-passage 134, and breathing-passage 136 may be a unitary and continuous airspace. Inlet-passage 132 may correspond to (being proximate to and in direct communication with) each at least one filter-port, being able to deliver air from at least one filter-port 112 to mouth-port 119 (FIG. 3), having checkvalve 160 embedded in at least one filter-port 112 in order to prevent backflow of air from mouth-port 119 (FIG. 3) of at least one filter-port 112.

Outlet-passage 134 may correspond to (being proximate to and in direct communication with) exhaust-port 114, being able to deliver air from mouth-port 119 (FIG. 3) to exhaust-port 114, having exhaust-valve 134 installed within or behind exhaust-port 114, preventing inflow from exhaust-port 114 to mouth-port 119 (FIG. 3).

In this way, air flows selectively in through inlet-passage 132, or out through outlet-passage 134, based simply on whether the user is inhaling or exhaling respectively, this selective action being controlled by the unidirectional nature of checkvalve 160 and exhaust-valve 134 respectively.

Mouthpiece 150 (FIG. 3) is anatomically shaped to create an air-tight seal to a user's mouth, mouthpiece 150 (FIG. 3) being affixed to or unitary with mouth-port 119 (FIG. 3), mouthpiece 150 (FIG. 3) being connected to breathing-channel 136, which itself is configured for the passage of breathable air. Breathing-channel 136 of interconnected hollow passageways 130 within mouthpiece 150 is simultaneously connected to inlet-passage 132 and outlet-passage 134. Inlet-passage 132 and outlet-passage 134 may be a unitary airspace, the unitary airspace having a C-shape, such that each terminus of the C-shape comprises one of at least one filter-port 112, and exhaust-port 114 is disposed at a center of the C-shape on the convex side, and mouth-port 119 (FIG. 3) is disposed at the center of the C-shape on the concave side. This shape, in an ideally envisioned embodiment, is illustrated.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A personal respirator comprising:
a manifold having an exhaust-port, at least one filter-port, and a mouth-port, the manifold having
an inlet-passage corresponding to each of at least one filter-port, the inlet-passage able to deliver air from the at least one filter-port to the mouth-port having a checkvalve preventing backflow of air from the mouth-port of the at least one filter-port;
an exhaust-port able to deliver air from the mouth-port to an exterior of the personal respirator;
a mouthpiece configured to attach to said mouth-port, said mouthpiece includes a breathing-channel configured for the passage of breathable air
a chamber within the mouthpiece simultaneously connected the inlet-passage and the outlet-passage; and
at least one filter, said at least one filter is configured to attach to said at least one filter-port.

2. The personal respirator of claim 1,
wherein said mouthpiece is anatomically shaped to create an air-tight seal to a user's mouth;
wherein said mouthpiece has an arch-shape corresponding to the curvature of the front of a set of teeth;
wherein the mouthpiece terminates in a skirt at either end of the arch-shape;
wherein a concave side of said mouthpiece includes two shelves able to be grasped between the set of teeth; and
wherein the two shelves respectively correspond to the skirt at either end of the arch shape.

3. The personal respirator of claim 2, wherein said mouthpiece further comprises
a connector extending from a convex side of the mouthpiece; and
an airway passing through the arch-shape and the connector.

4. The personal respirator of claim 3, wherein said mouthpiece further comprises
a rib circumscribing the connector, the rib being distal from the arch-shape.

5. The personal respirator of claim 2, wherein the mouthpiece is formed of an elastic and deformable material.

6. The personal respirator of claim 1, further comprising
a nose-shield integrated with the manifold; and
a noseclamp-interface cut into the nose-shield, the noseclamp-interface having
a dovetail; and
an opening interrupting the dovetail, the opening being wider than the dovetail.

7. The personal respirator of claim 6, further comprising
a noseclamp able to restrict the passage of air through a nose of a user when the personal respirator is worn, the noseclamp comprising
a terminus able to enter the opening and lock into the dovetail of the noseclamp-interface;
a right nose-clamp;
a left nose-clamp;
a wishbone joining the right nose-clamp and the left nose-clamp to the terminus.

8. The personal respirator of claim 7, wherein the right nose-clamp and the left nose-clamp each comprise a spring-member, such that the right nose-clamp and the left nose-clamp together apply pressure to either side of the nose of the user when the personal respirator is worn.

9. The personal respirator of claim 6, wherein the manifold further comprises an exhaust-shield extending over the exhaust-port, the exhaust-shield opening away distally from the nose-shield.

10. The personal respirator of claim 9, wherein a cavity is defined between the exhaust-shield and the exhaust-port, the cavity being perforated only by the exhaust-shield and the exhaust-port.

11. The personal respirator of claim 1, wherein the housing is no more than fifty percent of the weight of the personal respirator; and
wherein the personal respirator is balanceable no further towards the exhaust-port than the mouth-port, such that if the mouthpiece is held within the mouth, then the weight of the housing does not bias the personal breathing apparatus towards falling out of the mouth.

12. The personal respirator of claim 1, wherein the personal respirator may be retained to a user only by the user biting on the mouthpiece.

13. The personal respirator of claim 1, wherein the housing is constructed of resin.

14. The personal respirator of claim 1, wherein the checkvalve comprises
a flat and circular elastic membrane;
a frame having three arms and an aperture, each of the three arms able to slide into a corresponding slot of the filter-port, each of the three arms being parallel with each other and each three of the slot being parallel with each other;
a valve-fastener affixed centrally to the flat and circular elastic membrane and able to fasten to the aperture;
such that when the flat and circular elastic membrane is fastened by the valve-fastener to the frame, and the frame is inserted into the filter-port, the flat and circular elastic membrane covers and closes the filter-port against fluid communication with the inlet-passage; and
such that when a vacuum is applied to the inlet-passage, the flat and elastic circular elastic membrane will deform about the circumference and open the filter-port to fluid communication with the inlet-passage.

15. The personal respirator of claim 1, wherein the flat and circular elastic membrane is constructed of rubber.

16. The personal respirator of claim 1, wherein the flat and circular elastic membrane is constructed of silicone.

17. The personal respirator of claim 1, wherein the housing is constructed of one or more materials selected from the group consisting of resin, plastic, and rubber.
